(19) United States
(12) Patent Application Publication
(10) Pub. No.: US 2014/0362996 A1
(43) Pub. Date: Dec. 11, 2014

(54) STEREO SOUNDFIELD EXPANDER

(71) Applicants: Lloyd Trammell, Thousand Oaks, CA (US); John Gould, Moorpark, CA (US)

(72) Inventors: Lloyd Trammell, Thousand Oaks, CA (US); John Gould, Moorpark, CA (US)

(73) Assignee: Max Sound Corporation, La Jolla, CA (US)

(21) Appl. No.: 14/273,489

(22) Filed: May 8, 2014

Related U.S. Application Data
(60) Provisional application No. 61/821,031, filed on May 8, 2013.

(51) Int. Cl. H04S 1/00

(52) U.S. Cl. CPC H04S 1/007; H04S 2400/09
USPC 381/17

(57) ABSTRACT

An audio enhancement technique comprises a stereo audio source. The stereo audio source is split in two identical sound signals, with one of the split signals sent to a compare block and the other to an audio block. Output from the stereo audio source is fed to a stereo bus A block to create a processed audio. A bypass block for turning the processed audio on or off is provided. The output from the bypass block is fed to the compare block. The processed audio is outputted for use by user.

### CROSS-REFERENCE TO RELATED PATENT APPLICATIONS

Embodiments of the present invention relate to U.S. Provisional Application Ser. No. 61/821,031, filed May 8, 2013, entitled “NO NAME AUDIO SOUNDFIELD EXPANDER”, the contents of which are incorporated by reference herein and which is a basis for a claim of priority.

### BACKGROUND OF THE INVENTION

Modern music possesses little to no stereo field due to the amount of audio compression or even data compression into a lower format (Mp3, AAC, etc.). The conventional way to create an expanded stereo field is by using some type of delay, like chorus effect, reverb, or a simple delay on one side of the stereo audio. This creates an unrealistic soundfield. Using these kinds of effects, either independently or combined, for the soundfield expansion creates very strong and very audible phase problems. Sometimes this type of effect can cause a ringing effect as a comb filter would.

An improved stereo soundfield expander is required that addresses the above noted deficiencies of the conventional systems.

### SUMMARY OF THE INVENTION

A purpose of the inventive Max Sound (MS) stereo Soundfield Expander is to make a wider stereo image (a simulated distance increase between the left and right audio) for the listener to enjoy. This works particularly well with headphones. An end user will be able to control an amount of the effect on the soundfield to their liking with this process

The inventive MS Soundfield Expander comprises a stereo audio source. The stereo audio source is split in two identical sound signals, with one of the split signals sent to a compare block and the other to an audio block. Output from the stereo audio source is fed to a stereo bus A block to create a processed audio. A bypass block for turning the processed audio on or off is provided. The output from the bypass block is fed to the compare block. The processed audio is outputted for use by user.

Advantageously, the MS Soundfield Expander doesn't exhibit these problems as it works in a dynamic fashion which almost entirely deletes these audible issues. The end result is a clear, highly defined soundfield expansion with a greater amount of intelligibility.

In one embodiment, the inventive Soundfield Expander is used as a stand-alone software. It may also be used in the smart phone App as an enhancement to the existing App. It is intended to expand the spatial properties of existing audio. This can be used for both digital and analog audio listening devices and playback units.

### BRIEF DESCRIPTION OF THE DRAWINGS

FIG. 1 is a block diagram showing the signal flow according to an exemplary embodiment of the present invention.

FIG. 2 is a representation of how the levels of Stereo Bus A and Stereo Output change relative to each other according to an exemplary embodiment of the present invention.

FIG. 3 depicts a level meter according to each other according to an exemplary embodiment of the present invention.

FIG. 4 depicts a GUI of an exemplary embodiment of the present invention.

FIG. 5 is an expanded block diagram of an exemplary embodiment of the present invention.

### DETAILED DESCRIPTION OF THE PREFERRED EMBODIMENT(S)

Details of the present invention will now be discussed by reference to the drawings.

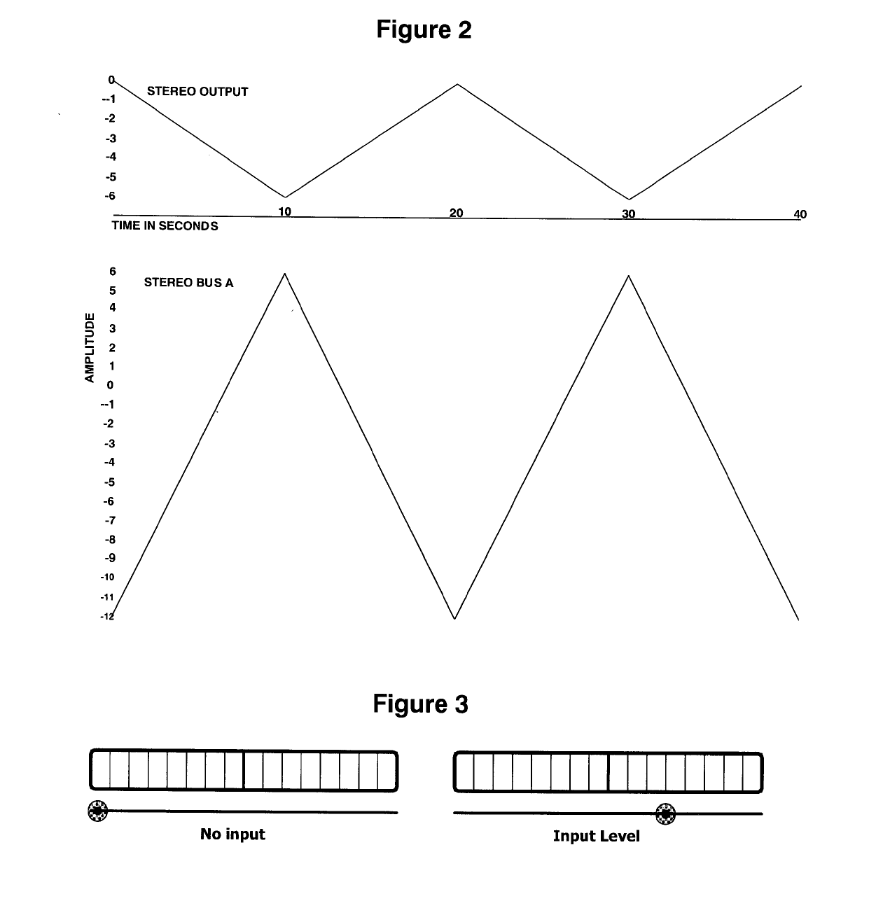

Referring to FIG. 2, the inventive process starts by taking the incoming audio and sending it into a block that splits, processes and combines the stereo stream into several different versions that are fed into the Stereo Bus A. Stereo Bus A is fed into a Compare Block that adjusts the amplitude of the original and processed audio by averaging. One skilled in the art would appreciate that this is not a compressor/limiter type block. Preferably there is a fixed ratio of 2.75 (Stereo Bus A) to 1 (Original Stereo Source) that operates in both positive and negative directions. The end result is an expanded stereo field that both expands and contracts as real audio does.

There will be a single “slider” or Stereo Amount that will adjust the mix of the audio from a zero to maximum amount with only a slight gain change in the overall amplitude. In addition, the amount could be driven by an envelope follower to create a dynamic soundfield that changes according to the setting of the envelope follower.

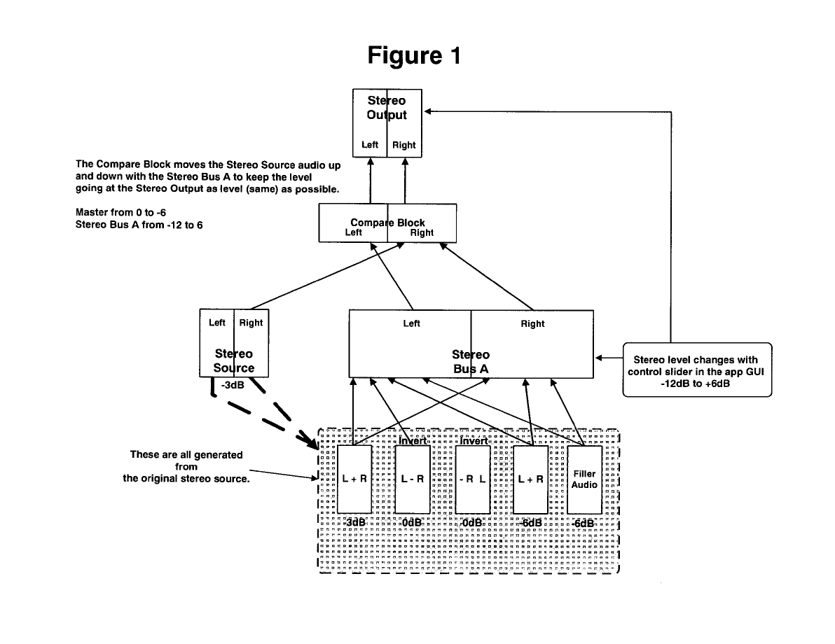

Referring to FIG. 1, a block diagram with signal flow is depicted according to an exemplary embodiment of the present invention. The STEREO SOURCE is mixed with the STEREO BUS A and the mix is fed to the Compare Block where the output signal stays very close to a constant amount. There are two separate tables for accomplishing this and are shown in FIG. 2. As the Stereo Amount slider moves up and down, it moves the values in FIG. 2 a corresponding amount to keep the level close to the same. It follows the dB amounts shown in FIG. 2.

As the control slider (Stereo Amount) moves up and down, it changes the values in a corresponding amount to keep the level close to the same. One skilled in the art would appreciate that this is not a compressor/limiter style of control. It follows the dB amounts shown in FIG. 2. The blocks are as follows:
1. L+R—the original left and right summed together and the output panned to center.
2. L−R—the original left and right with the right inverted and summed together. The output is panned to the left.
3. —R L—the original left and right with the left inverted and summed together. The output is panned to the right.
4. L+R—the original left and right summed together and panned to the center. This level is 6 dB lower than the original.
5. Filler Audio—the original left and right summed together and the output panned to center. There is a bandpass filter set for 55 Hz to 8.5 kHz. A delay is set for 30 ms for the left side only.
All of the above blocks feed into Stereo Bus A. Their levels are shown in FIG. 2.
6. Compare Block—this block is represented in FIG. 2 and explained above.

Both the Stereo Bus A and Stereo Output levels are controlled by a single control fader in the GUI. Their levels are shown in FIGS. 1 as (−12 to +6 dB).

FIG. 2 is an exemplary representation of how the levels of Stereo Bus A and Stereo Output change in relation to each other. Even though there are two complete cycles show, there is no modulation source; this is only to show an example of turning the control fader fully up and down twice. This will ensure that the output doesn't have a great increase as the Stereo Bus A level is increased.

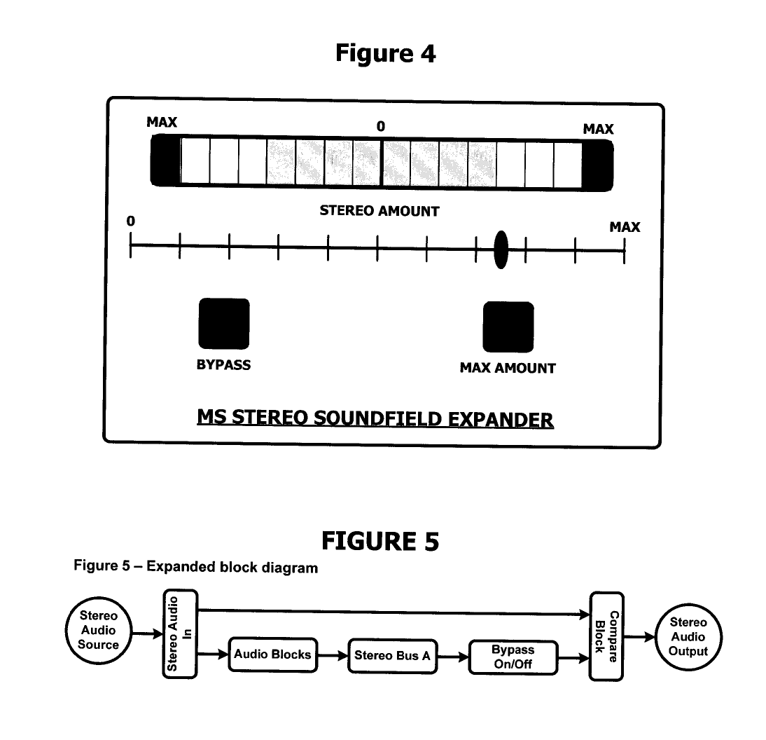

Referring to FIG. 4, a typical user GUI for the inventive process is depicted. The functions of each part/control are as follows:
1. Level Meter—visual display for the amount of stereo field expansion. This is driven by the amplitude of the input audio and shows the approximate amount at any given time.
2. Stereo Amount slider adjusts the amount of processing applied to the audio.
3. Bypass allows the user to turn the process on and off for comparison.
4. Max Amount turns the process amount to its maximum amount, regardless of where the slider is set. The slider will also move to the Max position.

Referring to FIG. 5, The source audio passes into the process. Once processed the audio is passed to the audio out. The audio path is as follows: A Stereo Audio Source is fed into a splitter which sends two identical stereo signal out. The top one goes directly into the Compare Block, while the second goes into the Audio Blocks section, then into the Stereo Bus A mixer. There is a Bypass in the path for the purpose of turning the processed audio on and off. When it is not bypassed, the audio from both the Stereo Audio In and the processed audio go into the Compare Block and becomes the mixed stereo output. If it is bypassed, then only the unprocessed audio appears at the output.

What is claimed is:

1. An audio enhancement technique comprising:
an audio stereo source;
Splitting the audio source in two identical sound signals and sending one of the split signals to a compare block and the other to an audio block;
Feeding the output from the audio block to a stereo bus A block to create a processed audio;
A bypass block for turning the processed audio on or off;
Feeding the output of the bypass block to the compare block;
Outputting the audio processed by the compare block as a stereo audio output.

2. The process of claim 1, wherein the compare block moves the audio source up and down with the stereo bus A to keep the level at the stereo output level.

3. The process of claim 1, wherein the stereo level changes with a control slider in a range of −12 db to +6 db.
